(19) United States
(12) Patent Application Publication
(10) Pub. No.: US 2026/0320292 A1
(43) Pub. Date: Oct. 15, 2026

(54) SYSTEM AND METHOD FOR PERFORMING LANGUAGE QUALITY ASSURANCE ON BILINGUAL TEXT SEGMENTS

(71) Applicants: Christopher Phillips, San Francisco, CA (US); Ibrahim Mohamed Menshawy, Cairo (EG); Raffaele Pascale, Mijas (ES)

(72) Inventors: Christopher Phillips, San Francisco, CA (US); Ibrahim Mohamed Menshawy, Cairo (EG); Raffaele Pascale, Mijas (ES)

(21) Appl. No.: 19/196,742

(22) Filed: May 2, 2025

Related U.S. Application Data
(60) Provisional application No. 63/787,954, filed on Apr. 13, 2025.

(51) Int. Cl. G06F 40/226

(52) U.S. Cl. CPC G06F 40/226

(57) ABSTRACT

A method executed by a language quality assurance system for evaluating bilingual text segments is disclosed. The method includes receiving bilingual source-target segment pairs for evaluation. The method also includes performing linguistic pre-processing on each segment pair. The method further includes analyzing each segment pair using a detection engine that comprises first AI model to identify potential linguistic quality issues in segment pairs, the analyzing including assigning severity level to identified issue. The method includes validating identified issues using validation and filtering engine that comprises second AI model trained to evaluate issue legitimacy based on contextual cues and historical quality benchmarks, the validating including adjusting severity levels. The method also includes flagging and routing validated issues to a human quality assurance expert for final determination. The method further includes generating structured language quality report summarizing issue types, frequencies, severities, and final determination for evaluated segment pairs.

### CROSS-REFERENCE TO RELATED APPLICATIONS

This application claims the benefit of U.S. Provisional Patent Application No. 63/787,954 filed on Apr. 13, 2025, the entire disclosure of which is incorporated herein by reference.

### FIELD OF THE INVENTION

The present invention relates generally to the field of computer-assisted translation and language quality assurance, and more specifically, to a system and method for performing language quality assurance (LQA) on bilingual text segments by utilizing multiple AI agents.

### BACKGROUND OF THE INVENTION

Language Quality Assurance (LQA), in the localization industry, helps translated content maintain high standards of accuracy, fluency, cultural appropriateness, and terminological consistency. Traditionally, LQA has relied on human reviewers to evaluate a subset of translated content. The human reviewers typically assess translations for a number of issues, including grammatical errors, semantic inaccuracies, stylistic inconsistencies, and violations of client-specific terminology or guidelines.

While human-led LQA provides expert insights and nuanced judgment, such reviews are accompanied by significant limitations that hinder scalability, consistency, and efficiency in modern content workflows.

In some instances, given the time and cost associated with manual review, only a small percentage of the total localized content is typically sampled for evaluation. As a result, many translation errors go undetected, potentially compromising the overall quality of deliverables and leading to reputational or legal risks for enterprises. Further, manual LQA requires skilled linguists with domain expertise, especially in high-stakes or regulated industries (e.g., medical, legal, technical content). Recruiting and retaining such professionals is expensive and logistically challenging, especially across multiple language pairs and markets.

Despite the use of guidelines and scoring frameworks, human evaluations vary based on individual reviewer interpretations such that it introduces subjectivity and inconsistency in scoring and feedback, resulting in reduced reliability and comparability of LQA results across projects, vendors, or languages. Many existing LQA workflows lack automation or rely solely on simplistic models. For instance, reference systems such as those disclosed in: U.S. Patent Publication No. 20220067307 and PCT Publication No. WO2024032691 focus on automated quality estimation using models like COMET-MQM or BLEURT but do not incorporate any human-in-the-loop validation or feedback mechanisms, and U.S. Patent Publication Nos. 20200193097 and 20230025739 describe feedback-driven or quality prediction systems, but these only refine translation models indirectly and lack structured issue taxonomies or severity classification.

Prior art including U.S. Pat. Nos. 9,152,622 and 8,566,078 incorporate human feedback for translation model personalization or gamified rating but do not leverage dual AI validation agents or real-time human-in-the-loop quality control. Further, existing systems generally provide flat scoring models or limited classifications. In contrast, more nuanced LQA requires issue classification across dimensions such as accuracy, fluency, terminology, and style—each with varying severities. Systems like Chinese Patent Application No. 113609875 evaluate at sentence and word levels but do not include validation agents, dynamic severity calibration, or adaptive learning from human feedback. Thus, existing methods lack mechanisms for continuous learning. Even when feedback exists, it typically does not feed back into structured models to improve issue detection or reviewer alignment over time.

Therefore, there is a need for an automated and intelligent LQA framework for evaluating 100% of translated content without compromising on quality or contextual relevance, integrates multi-layer AI processing with targeted human validation, and dynamically calibrates issue severity based on content type, past feedback, and configurable thresholds.

### SUMMARY OF THE INVENTION

It is an objective of the present invention to provide a method and system for performing language quality assurance (LQA) across 100% of bilingual content.

It is another objective of the present invention to enable accurate detection of linguistic quality issues using an artificial intelligence (AI) agent.

It is yet another objective of the present invention to validate and refine detected issues through another AI agent, thereby improving overall precision.

It is a further objective of the present invention to minimize human reviewer workload by routing only AI-validated issues for final assessment.

It is an additional objective of the present invention to implement a human-in-the-loop mechanism that enhances system adaptability through structured feedback.

It is also an objective of the present invention to support customizable quality evaluation frameworks such as Multidimensional Quality Metrics (MQM) dynamically within the AI models.

It is another objective of the present invention to generate modular and exportable quality assurance reports for integration with Translation Management Systems (TMS).

It is a further objective of the present invention to continuously improve AI agent performance through a feedback loop that incorporates human-confirmed corrections.

According to an exemplary embodiment of the present invention, a method executed by a language quality assurance (LQA) system for evaluating bilingual text segments is disclosed. The method includes receiving a plurality of bilingual source-target segment pairs for evaluation. The method also includes performing linguistic pre-processing on each segment pair for further analysis. The method further includes analyzing each segment pair using a detection engine, the detection engine comprising a first AI model to identify potential linguistic quality issues in the segment pairs, the analyzing including assigning a severity level to each identified issue, the severity level being selected from a group consisting of: minor, major, and critical. The method includes validating the identified issues using validation and filtering engine, the validation and filtering engine comprising a second AI model trained to evaluate issue legitimacy based on contextual cues and historical quality benchmarks, the validating including adjusting the severity levels of the identified issues. The method also includes flagging and routing validated issues to a human quality assurance expert for final determination, the issues routed to the human quality assurance expert being limited to those classified as critical. The method further includes generating a structured language quality report summarizing issue types, frequencies, severities, and final determination for the evaluated segment pairs.

### BRIEF DESCRIPTION OF DRAWINGS

FIG. 1 is a block diagram of a system for performing language quality assurance (LQA) on bilingual text segments by utilizing multiple agents.

FIG. 2 is a flowchart illustrating a method for performing LQA on bilingual text segments by utilizing multiple agents.

FIG. 3 is a block diagram of a computer system.

### DETAILED DESCRIPTION OF THE INVENTION

The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention. For a more complete understanding of the present invention, reference is now made to the following descriptions taken in conjunction with the accompanying drawings.

The present invention language quality assurance (LQA) system capable of evaluating on bilingual text content using a hybrid artificial intelligence (AI) and human-in-the-loop framework. The system supports adaptive quality scoring, dynamic severity calibration, and integration with enterprise localization infrastructures. The system is configured to receive bilingual source-target segment pairs and apply a multi-stage AI evaluation process. The system is applicable across a wide range of use cases, including enterprise-level evaluation of localized product content, quality monitoring of machine translation outputs, streamlined post-editing validation workflows, and auditing of multilingual legal or regulatory documentation. By prioritizing human review and learning from reviewer input, the system supports efficient, scalable, and consistent quality assurance for high-volume translation environments.

In certain embodiments, the present invention further supports integration with quality frameworks such as the Multidimensional Quality Metrics (MQM) and includes export functionality for structured quality reporting. Evaluation data, including issue-level and segment-level insights, can be delivered in formats such as Excel or JSON, or transmitted via APIs to translation management systems (TMS) or business intelligence dashboards. These capabilities provide enterprise users with actionable insights and end-to-end visibility into language quality operations.

In various embodiments, the system delivers complete content coverage with reduced manual effort, high consistency in scoring and evaluation, and a scalable architecture suitable for global deployment. The adaptive learning mechanisms ensure that the system or AI-models continuously evolves in alignment with linguistic trends, reviewer behavior, and domain-specific quality standards.

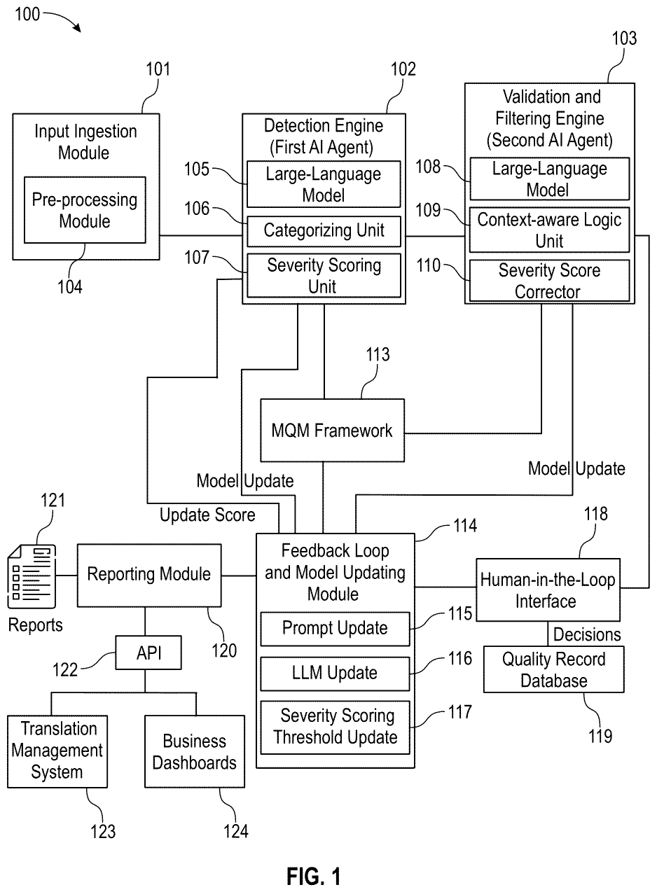

According to an embodiment of the present invention, a language quality assurance (LQA) system 100 to evaluate bilingual text content with enhanced efficiency, precision, and adaptability through a hybrid AI-human feedback architecture is disclosed. Referring to FIG. 1, the system 100 comprises a plurality of components including an input ingestion module 101, pre-processing module 104, a detection engine 102 comprising (i) a first AI model 105, (ii) a categorizing unit 106, and (iii) a severity scoring unit 107, a validation and filtering engine 103 comprising (i) a second AI model 108, (ii) a context-aware logic unit 109, and (iii) a severity score corrector 110, a human-in-the-loop user interface (UI) 118, a quality record database 119, a feedback loop and model updating module 114, a reporting module 120 integrating via an application programming interface (API) 122 with one or more business dashboards 124 or a translation management system 123. These components are communicatively coupled to enable end-to-end system functionality.

It should be understood that although the term “unit” or “module” is used herein to describe various components of the system, each unit or module is not necessarily a separate physical element or hardware component. Rather, the functionalities attributed to each unit or module may be implemented as one or more software routines, instructions, or code segments that are stored in a non-transitory memory and executed by one or more processors. As such, the system is not limited to a particular hardware architecture and may be realized as a software platform, virtualized environment, or distributed computing system.

Referring to FIG. 1, the system 100 receives a plurality of bilingual source-target segment pairs via the input ingestion module 101 for evaluation. These segment pairs typically consist of content in a source language and corresponding translations in a target language that require quality assessment. In one or more aspects, the input ingestion module 101 supports multiple input formats including XML, XLIFF, JSON, and plain text files. The pre-processing module 104 prepares the segment pairs for further analysis.

The detection engine 102 comprises the first AI model 105 which is trained on MQM standards to identify potential linguistic quality issues in the segment pairs.

In an exemplary embodiment, during analysis by the first AI model 105, the categorizing unit 106 classifies each identified issue into a predefined taxonomy of error types, including but not limited to accuracy, fluency, terminology, and style. The classification employs a hierarchical taxonomy with major categories subdivided into specific error types. For example, accuracy errors might include omissions, additions, mistranslations, and semantic drift.

In another exemplary embodiment, the severity scoring unit 107 assigns a severity level to each identified issue, with severity levels being selected from a group consisting of minor, major, and critical. The severity assignment employs a complex heuristic that considers factors including but not limited to potential impact on user comprehension, risk of functional errors in product use, visibility of the text in a user interface, and legal or safety implications of the error. For example, a terminology error in a medical device interface may receive a higher severity rating than the same error type in marketing content.

The validation and filtering engine 103 comprises the second AI model 108 trained to evaluate issue legitimacy based on contextual cues and historical quality benchmarks. In an exemplary aspect, the validation engine 103 utilizes the severity score corrector to discard false positives and adjusts the assigned severity levels of identified issues using a context-sensitive evaluation process based on dynamic quality thresholds. The dynamic quality thresholds are derived from historical performance metrics gathered from past reviews, human quality assurance expert feedback and correction patterns, content type specifications (e.g., marketing content might have different thresholds than technical documentation), and client-specific quality expectations encoded as configuration parameters.

In another exemplary embodiment, the validation engine 103 employs a statistical model to predict false positive probability for each detected issue. Additionally, the validation engine 103 can detect systematic errors across multiple segments, and group them together to avoid overwhelming reviewers with repetitive issues.

In another embodiment, the system 100 supports integration with configurable quality evaluation frameworks 113, including but not limited to the Multidimensional Quality Metrics (MQM) 113. Parameters of the selected framework are dynamically incorporated into the first and second AI models 105, 108 through prompt design or scoring instruction encoding. In an example, the integration of MQM framework 113 allows for custom error taxonomies beyond the standard categories, weighted scoring systems that reflect client priorities, industry-specific quality metrics for specialized domains, and compliance checking against regulatory standards for specific industries.

In an exemplary embodiment, the user interface (UI) module 118, also referred to as a human-in-the-loop module 118, routes validated issues to at least one human quality assurance expert (also referred to as a human reviewer) for final determination. To optimize human reviewer time and focus, the issues routed to the human quality assurance expert may be limited to those classified as critical. In some aspects, for each issue, the UI module 118 displays the error type and subtype, the current severity level, the specific text span affected, a description of the issue, and one or more suggested corrections generated by the AI models 105, 108.

The feedback loop and model updating module 114 receives feedback input from the human quality assurance expert through the UI module 118, and records confirmation of validated issues, modifications to AI-model suggested corrections, reassignments of issue types or severity levels, or rejection of issues as false positives. In one aspect, the system 100 stores the aforesaid input in a quality record database 119. Each feedback record contains the original segment pair, the detected issue details, the validation engine assessment, the human reviewer decision, any corrections applied, metadata including timestamps, reviewer ID, and project context. In some aspects, the system 100 employs a data pipeline that processes incoming feedback in real-time, updating quality metrics dashboards and feeding into the model refinement process.

The feedback loop and model updating module 114 utilizes the human expert feedback to improve or refine 116 the AI models 105, 108. In one aspect, the refinement process 116 includes: prompt parameter adjustment 115 and quality threshold recalibration 117. In an exemplary embodiment, the reporting module 120 generates structured language quality reports 121 summarizing, for example, issue types, frequencies, severities, and reviewer (or final reviewer) decisions for the evaluated segment pairs. The reports 121 include both issue-level and segment-level insights, and can be exported in multiple formats. For example, reports 121 can be exported in multiple machine-readable formats including Excel, JSON, or through application programming interfaces (APIs) 122 integrated with one or more external translation management systems (TMS) 123 and one or more business dashboards 124. For example, the API 122 implementation follows REST principles with OAuth 2.0 authentication and supports webhook notifications when new reports become available.

The combination of AI-based issue detection and validation components with targeted human expert review creates an efficient and effective quality assurance system that significantly reduces the time and effort required for comprehensive linguistic quality evaluation while maintaining high accuracy standards.

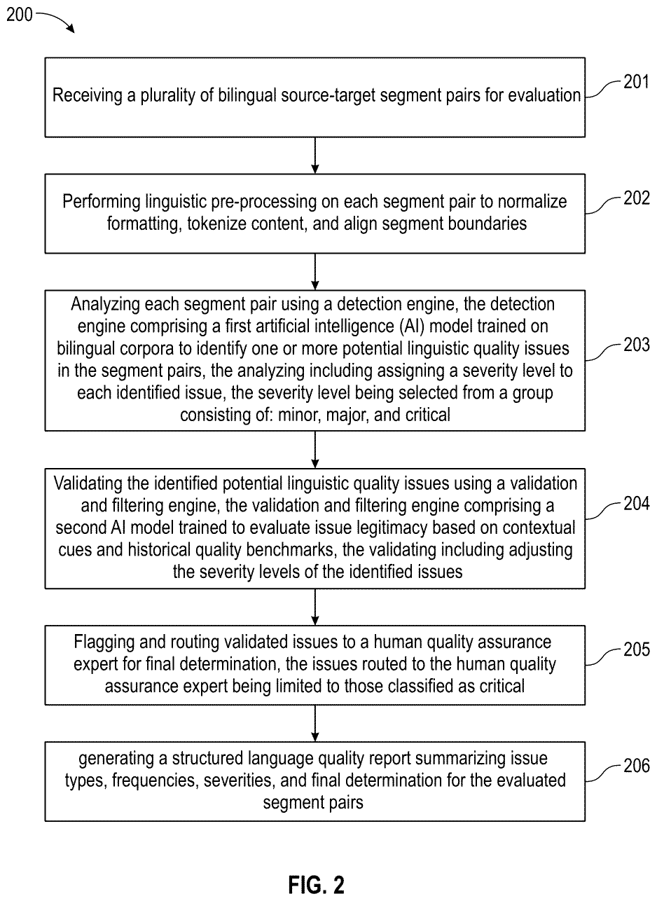

According to another exemplary embodiment of the present invention, referring FIG. 2, a method 200 executed by a language quality assurance (LQA) system for evaluating bilingual text segments is disclosed. The method 200 employs a plurality of artificial intelligence (AI) models in combination with human expertise to efficiently identify, validate, and resolve linguistic quality issues in translated content. The method 200 provides a sequential process for comprehensive translation quality assessment while minimizing the human review workload through intelligent issue detection and validation.

The method 200 involves receiving 201 a plurality of bilingual source-target segment pairs for evaluation. The segment pairs consist of content in a source language and corresponding translations in a target language that require quality assessment. The system receives the segment pairs through various input channels including file uploads, API submissions, or direct integration with translation management systems. In one or more aspects, the system accepts multiple input formats including XML, XLIFF, JSON, and plain text files. The receiving step includes validation of the input data to ensure that source and target segments are properly paired and that all required metadata is present.

After receiving the segment pairs, the method 200 performs linguistic pre-processing 202 on each segment pair. The pre-processing step prepares the text further for analysis. Following pre-processing, the method 200 analyzes 203 each segment pair using a detection engine. The detection engine comprises a first artificial intelligence (AI) model to identify potential linguistic quality issues in the segment pairs.

During analysis, the method 200 classifies each identified issue into a predefined taxonomy of error types, including but not limited to accuracy, fluency, terminology, and style. Each major category contains subcategories for specific error types. In a specific aspect, the method 200 assigns a severity level to each identified issue, with severity levels being selected from a group consisting of minor, major, and critical. The severity assignment considers factors such as impact on content usability, potential for user confusion, visibility of the affected text, and legal or safety implications.

After the initial analysis, the method 200 validates 204 the identified potential linguistic quality issues using a validation and filtering engine. The validation and filtering engine comprises a second AI model trained to evaluate issue legitimacy based on contextual cues and historical quality benchmarks.

The validation process involves one or more significant steps: discarding false positives and adjusting severity levels. In discarding false positives step, the second AI model evaluates each identified issue in context to determine whether it represents a genuine quality problem or a false positive. The second AI model calculates a legitimacy score for each issue and filters out those determined to be false positives. Further, in the step of adjusting severity levels, the validation process refines the initially assigned severity levels using a context-sensitive evaluation process, wherein this step is based on dynamic quality thresholds defined by historical performance metrics from past reviews, human quality assurance expert feedback patterns, content type specifications, and client-specific quality expectations.

After validation, the method 200 flags and routes 205 validated issues to a human quality assurance expert for final determination. To optimize human reviewer time and focus, the issues routed to the human quality assurance expert may be limited to those classified as critical. The routing process includes issue prioritization, reviewer assignment based on language pair and domain expertise, and workload balancing. The system presents the flagged issues to reviewers through a user interface that displays the source-target segment pairs containing validated issues, along with detailed issue information and optionally generated correction suggestions. The user interface (UI) enables efficient review by highlighting specific issue locations within the text, providing context information, and offering inline editing capabilities for immediate correction.

The method 200 includes receiving final determination input from the human quality assurance expert. This input is captured via the UI and may indicate one of several possible decisions including confirmation of the validated issue as a genuine quality concern, modification of the AI-model suggested corrections, reassignment of the issue type or severity level, and rejection of the issue as a false positive.

The human judgment step provides critical validation and refinement of the AI-based assessment, such that the final quality evaluation reflects both automated intelligence and human linguistic expertise. The method 200 records the human expert input in a quality record database, such that a continuous learning and feedback loop is created that progressively improves system accuracy over time.

In various embodiments, the method 200 further includes using the final determination data to refine the AI models. The refinement process includes: prompt parameter adjustment and quality threshold recalibration. Finally, the method 200 generates 206 a structured language quality report summarizing issue types, frequencies, severities, and final determinations for the evaluated segment pairs. The reports include both issue-level and segment-level insights, and can be exported in multiple formats. In one aspect, the reports can be generated with customized views for different stakeholders. For example, reports can be exported in multiple machine-readable formats including Excel, JSON, or through application programming interfaces (APIs) integrated with external Translation Management Systems. For example, the API implementation follows REST principles with OAuth 2.0 authentication and supports webhook notifications when new reports become available.

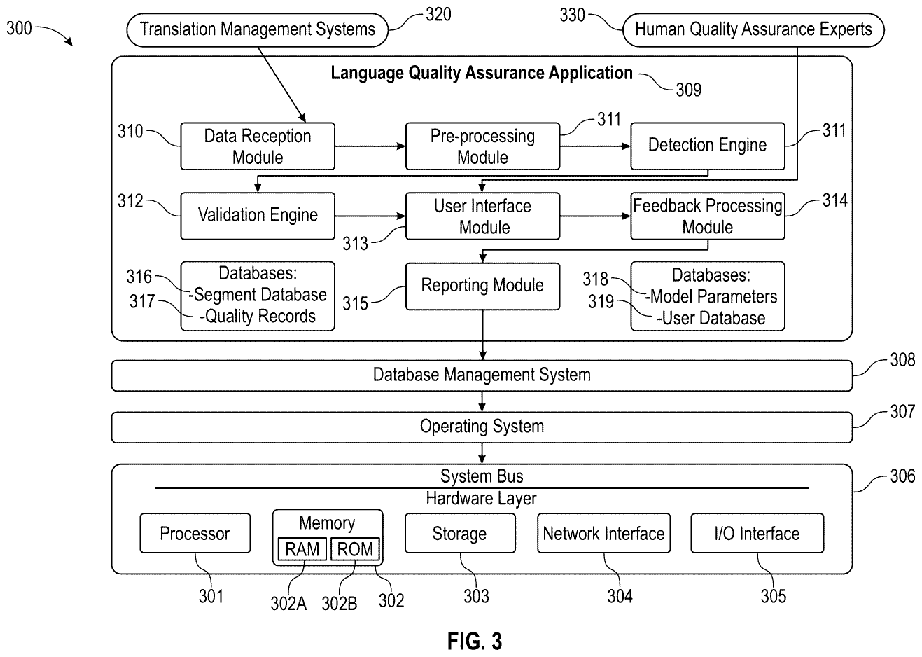

According to another embodiment, the present invention may be implemented as a computer system 300, as shown in FIG. 3, for evaluating the quality of bilingual translations. The computer system 300 provides an efficient process for identifying, validating, and resolving linguistic quality issues in translated content using artificial intelligence models in combination with human expertise.

Referring to FIG. 3, the computer system 300 comprises a plurality of hardware and software components that work together to implement language quality assurance (LQA) functionality described herein. The system 300 includes a processor 301 coupled to a system bus 306. The processor 301 may be implemented as a single or multi-core CPU capable of executing instructions stored in a memory. In one embodiment, the processor 301 comprises a multi-core CPU to efficiently handle the computational demands of a plurality of artificial intelligence (AI) models as disclosed in preceding embodiments.

The system 300 further includes a memory subsystem coupled to the system bus, the memory subsystem comprising both volatile memory (such as RAM) 302A and non-volatile memory (such as ROM) 302B. The memory 302 stores computer-executable instructions and data used by the processor during operation. A storage unit 303 is also coupled to the system bus 306 and provides persistent storage for program instructions and data. The storage unit 303 may be implemented as a solid-state drive (SSD), hard disk drive (HDD), or other suitable mass storage technology. The storage unit 303 stores an operating system, one or more application programs, a plurality of AI model parameters, and databases containing historical quality assessment data.

A network interface 304 or a network interface controller is coupled to the system bus 306 and provides connectivity to external networks such as local area networks (LANs) and wide area networks (WANs) including the Internet. The interface 304 enables the system 300 to receive bilingual segment pairs for evaluation from remote translation management systems 320 and to transmit quality reports to external systems. An input/output (I/O) interface 305 is coupled to the system bus 306 and provides connectivity to a plurality of input and output devices including displays, keyboards, pointing devices, and other peripherals used for system administration and interaction with one or more human quality assurance experts.

The computer system 300 implements a multilayered software architecture comprising several functional modules that execute on the processor 301 using the memory 302 and storage unit 303.

At the lowest level, an operating system 307 manages hardware resources and provides services to higher-level applications. The operating system 307 may be a commercially available system such as Linux, Windows Server, or macOS, or a specialized real-time operating system optimized for AI processing. A database management system (DBMS) 308 provides structured storage and retrieval capabilities for the various data types used by the system 300, including segment pairs, evaluation results, user feedback, and model training data.

In an embodiment, the core language quality assurance (LQA) application 309 comprises several specialized modules: A data reception module (input ingestion module) 310 that receives bilingual source-target segment pairs through the network interface 304 or from local storage 303, validates their format and structure, and prepares them for processing. A pre-processing module 311 that normalizes the segment pairs to prepare the text for further analysis. A detection engine 311 that implements the first AI model, which analyzes segment pairs to identify potential linguistic quality issues. A validation and filtering engine 312 that implements the second AI model, which evaluates issue legitimacy and adjusts severity levels. A user interface module 313 that presents validated issues to human quality assurance experts and captures their input. A feedback processing module 314 that records human expert determinations and uses them to refine the AI models. A reporting module 315 that generates structured quality reports summarizing evaluation results.

In an embodiment, the processor 301 executes the instructions stored in memory 302 to implement the LQA method 200 as described in preceding embodiments. The processor 301 loads the AI models from storage unit 303 into memory 302 for efficient execution. The first AI model is loaded into memory 302 when segment pairs are being analyzed, while the second AI model is loaded during the validation phase. The system 300 implements a pipelined processing architecture that enables concurrent processing of multiple segment pairs at different stages of the workflow. While one set of segments is being pre-processed, another set may be undergoing AI analysis, and yet another set may be in the validation phase.

For particularly demanding processing tasks, the system 300 may utilize specialized hardware accelerators if available, such as graphics processing units (GPUs) or tensor processing units (TPUs), to speed up the execution of the AI models.

The system 300 maintains one or more databases in storage unit 303, including: A segment database 316 storing source-target segment pairs. A quality record database 317 storing evaluation results and human feedback. A model parameters database 318 storing the current state of the AI models. A user database 319 storing authenticating information and preferences for human reviewers 330. Through the integrated hardware and software architecture, the computer system 300 provides a platform for efficient LQA, combining the computational power of AI with the linguistic expertise of human reviewers 330.

It will finally be understood that the disclosed embodiments are presently preferred examples of how to make and use the claimed invention, and are intended to be explanatory rather than limiting the scope of the invention as defined by the claims below. Reasonable variations and modifications of the illustrated examples in the foregoing written specification and drawings are possible without departing from the scope of the invention as defined in the claim below. It should further be understood that to the extent the term “invention” is used in the written specification, it is not to be construed as a limited term as to number of claimed or disclosed inventions or the scope of any such invention, but as a term which has long been conveniently and widely used to describe new and useful improvements in technology. The scope of the invention supported by the above disclosure should accordingly be construed within the scope of what it teaches and suggests to those skilled in the art, and within the scope of any claims that the above disclosure supports. The scope of the invention is accordingly defined by the following claims.

1. A method executed by a language quality assurance (LQA) system for evaluating bilingual text segments, the method comprising:
receiving a plurality of bilingual source-target segment pairs for evaluation;
performing linguistic pre-processing on each segment pair to normalize the segments;
analyzing each segment pair using a detection engine, the detection engine comprising a first artificial intelligence (AI) model to identify one or more potential linguistic quality issues in the segment pairs, the analyzing including assigning a severity level to each identified issue, the severity level being selected from a group consisting of: minor, major, and critical;
validating the identified potential linguistic quality issues using a validation and filtering engine, the validation and filtering engine comprising a second AI model trained to evaluate issue legitimacy based on contextual cues and historical quality benchmarks, the validating including adjusting the severity levels of the identified issues;
flagging and routing validated issues to a human quality assurance expert for final determination, the issues routed to the human quality assurance expert being limited to those classified as critical; and
generating a structured language quality report summarizing issue types, frequencies, severities, and final determination for the evaluated segment pairs.

2. The method of claim 1, wherein the analyzing comprising:
classifying each identified issue into a predefined taxonomy of error types, including but not limited to accuracy, fluency, terminology, and style; and
assigning the severity level to the identified issues.

3. The method of claim 1, wherein the validating comprising:
discarding false positives; and
adjusting the severity level of the issues using a context-sensitive evaluation process and based on dynamic quality thresholds defined by historical performance, human quality assurance expert feedback, or content type.

4. The method of claim 1, wherein the first AI model uses a transformer-based language model to assess linguistic equivalence between the source and target texts, detect terminology mismatches, flag stylistic inconsistencies, and assess grammatical correctness.

5. The method of claim 1, wherein the second AI model analyzes issue metadata, severity history, reviewer trends, and segment-specific context to evaluate whether detected issues are legitimate or represent false positives.

6. The method of claim 1, wherein the routing validated issues to the human quality assurance expert further comprises presenting, via a user interface, only those segment pairs containing issues validated by the second AI model to the human reviewer, along with optionally generated correction suggestions, by at least one of the AI models, corresponding to the validated issues.

7. The method of claim 1, wherein the final determination by the human quality assurance expert further comprises:
receiving an input, via the user interface, from the human reviewer indicating one of:
confirmation of the validated issue, modification of the AI-model suggested corrections, reassignment of the issue type or severity level, or rejection of the issue as a false positive; and
recording the input in a quality record database.

8. The method of claim 7, further comprising:
using final determination to refine the AI models by adjusting prompt parameters or recalibrating quality thresholds for creating a continuous learning and feedback loop.

9. The method of claim 2, wherein the classification and severity scoring of identified issues is performed in accordance with one or more configurable quality evaluation frameworks, including but not limited to the Multidimensional Quality Metrics (MQM), and wherein parameters of the selected framework are dynamically incorporated into the AI models through prompt design or scoring instruction encoding.

10. The method of claim 1, wherein the generating structured language quality report comprising: exporting the language quality data comprising, issue-level and segment-level insights, in one or more machine-readable formats including Excel, JSON, or through application programming interfaces (APIs) integrated with external Translation Management Systems.

11. A system comprising a processor and memory, wherein the processor and memory in combination are operable to implement a method comprising:
receiving a plurality of bilingual source-target segment pairs for evaluation;
performing linguistic pre-processing on each segment pair to normalize the segment;
analyzing each segment pair using a detection engine, the detection engine comprising a first artificial intelligence (AI) model to identify one or more potential linguistic quality issues in the segment pairs, the analyzing including assigning a severity level to each identified issue, the severity level being selected from a group consisting of: minor, major, and critical;
validating the identified potential linguistic quality issues using a validation and filtering engine, the validation and filtering engine comprising a second AI model trained to evaluate issue legitimacy based on contextual cues and historical quality benchmarks, the validating including adjusting the severity levels of the identified issues;
flagging and routing validated issues to a human quality assurance expert for final determination, the issues routed to the human quality assurance expert being limited to those classified as critical; and
generating a structured language quality report summarizing issue types, frequencies, severities, and final determination for the evaluated segment pairs.

12. The system of claim 11, wherein the analyzing comprising:
classifying each identified issue into a predefined taxonomy of error types, including but not limited to accuracy, fluency, terminology, and style; and
assigning the severity level to the identified issues.

13. The system of claim 11, wherein the validating comprising:
discarding false positives; and
adjusting the severity level of the issues using a context-sensitive evaluation process and based on dynamic quality thresholds defined by historical performance, human quality assurance expert feedback, or content type.

14. The system of claim 11, wherein the first AI model uses a transformer-based language model to assess linguistic equivalence between the source and target texts, detect terminology mismatches, flag stylistic inconsistencies, and assess grammatical correctness.

15. The system of claim 11, wherein the second AI model analyzes issue metadata, severity history, reviewer trends, and segment-specific context to evaluate whether detected issues are legitimate or represent false positives.

16. The system of claim 11, wherein the routing validated issues to the human quality assurance expert further comprises presenting, via a user interface, only those segment pairs containing issues validated by the second AI model to the human reviewer, along with optionally generated correction suggestions, by at least one of the AI models, corresponding to the validated issues.

17. The system of claim 11, wherein the final determination by the human quality assurance expert further comprises:
receiving an input, via the user interface, from the human reviewer indicating one of: confirmation of the validated issue, modification of the AI-model suggested corrections, reassignment of the issue type or severity level, or rejection of the issue as a false positive; and
recording the input in a quality record database.

18. The system of claim 17, further comprising:
using final determination to refine the AI models by adjusting prompt parameters or recalibrating quality thresholds for creating a continuous learning and feedback loop.

19. The system of claim 12, wherein the classification and severity scoring of identified issues is performed in accordance with one or more configurable quality evaluation frameworks, including but not limited to the Multidimensional Quality Metrics (MQM), and wherein parameters of the selected framework are dynamically incorporated into the AI models through prompt design or scoring instruction encoding.

20. The system of claim 11, wherein the generating structured language quality report comprising: exporting the language quality data comprising, issue-level and segment-level insights, in one or more machine-readable formats including Excel, JSON, or through application programming interfaces (APIs) integrated with external Translation Management Systems.
